(19) United States
(12) Patent Application Publication
(10) Pub. No.: US 2007/0100758 A1
(43) Pub. Date: May 3, 2007

(54) Method for law firms to assist clients in acquiring and commercially exploiting intellectual property

(75) Inventors: Michael D. Schumann, Plymouth, MN (US); James A. Larson, Maplewood, MN (US)

Correspondence Address: HAMRE, SCHUMANN, MUELLER & LARSON, P.C., P.O. BOX 2902, MINNEAPOLIS, MN, 55402-0902, US

(73) Assignee: HAMRE, SCHUMANN, MUELLER & LARSON, P.C., Minneapolis, MN (US)

(21) Appl. No.: 11/549,187

(22) Filed: Oct. 13, 2006

Related U.S. Application Data
(60) Provisional application No. 60/726,730, filed on Oct. 14, 2005.

(51) Int. Cl. G06Q 99/00; H04L 9/00; H04K 1/00

(52) U.S. Cl. 705/51

(57) ABSTRACT

Methods for facilitating commercial exploitation of IPR and IPR-related opportunities by a law firm on behalf of law firm clients are described, including posting on a law firm website IPR and IPR-related opportunities that clients of the law firm are interested in soliciting offers for possible commercial exploitation, and posting on a law firm website IPR, IPR-related opportunities, technology information, etc. sought by law firm clients.

This application claims benefit to U.S. Provisional application Ser. No. 60/726,730, filed Oct. 14, 2005, which application is incorporated herein by reference.

### TECHNICAL FIELD

This technical disclosure relates to methods for facilitating commercial exploitation of intellectual property rights (hereinafter “IPR”) and IPR-related opportunities. More particularly, the disclosure relates to methods for facilitating commercial exploitation of IPR and IPR-related opportunities by a law firm on behalf of law firm clients, including posting on a law firm website IPR and IPR-related opportunities that clients of the law firm are interested in soliciting offers for possible commercial exploitation, and posting on a law firm website IPR, IPR-related opportunities, technology information, etc. sought by law firm clients.

### BACKGROUND

There are many entities that have and that would like to acquire IPR and IPR-related opportunities. Examples of these entities include corporations, manufacturers, governments, individuals, etc. These entities often have inventions, ideas, ongoing research and development, technical know-how, trademarks, original works of authorship, etc. that they may be interested in commercially exploiting with, or seeking investments from, other parties. These same entities may also be interested in acquiring certain IPR and investing in IPR-related opportunities from other parties. However, many of these entities lack a venue to promote their own IPR and IPR-related opportunities, and lack a venue for learning about possible IPR and IPR-related opportunities from other parties.

A law firm that practices in the area of intellectual property is often asked by clients of the law firm to assist in a number of IPR-related services, including acquiring IPR for clients, licensing and sales transactions involving IPR, reviewing IPR-related agreements, providing legal advice relating to client's IPR, etc. Often times, a law firm that practices in intellectual property law acts as an intermediary between their clients and third parties on IPR, and IPR-related, transactions.

Increasingly, a law firm web site provides a convenient mechanism by which law firm clients and third parties can interact with the law firm, for example acquiring information on the law firm and its services. This is especially true for clients and third parties located far away from the law firm, for example in another country where time differences and/or language barriers may make direct contact with specific individuals in the law firm difficult or inconvenient.

In view of the foregoing, a law firm website is an excellent venue for facilitating the commercial exploitation of IPR and IPR-related opportunities between clients of the law firm and third parties.

### SUMMARY

Methods for facilitating commercial exploitation of IPR and IPR-related opportunities by a law firm on behalf of law firm clients are described, including posting on a law firm website IPR and IPR-related opportunities that clients of the law firm are interested in soliciting offers for possible commercial exploitation, and posting on a law firm website IPR, IPR-related opportunities, technology information, etc. sought by law firm clients.

When a law firm client is seeking offers for possible commercialization of IPR and/or IPR-related opportunities owned by the law firm client, the method includes acquiring information from the law firm client on the IPR and/or IPR-related opportunity that the client wants to solicit offers for possible commercial exploitation, and posting the information on the IPR and/or IPR-related opportunity on the law firm website along with an indication that the IPR and/or IPR-related opportunity is available for possible commercial exploitation.

In an exemplary embodiment, the method could be used for soliciting offers for financial funding of, for example, the costs of a patent application or the costs of a business venture of the client. In another exemplary embodiment, if the law firm client is considering abandoning a patent application or patent, or is considering whether or not to pursue foreign filing opportunities in certain countries, the availability of these IPR opportunities could be posted on the law firm website to solicit third parties who may be interested in purchasing the IPR opportunity or providing funding for the IPR opportunity.

When a law firm client is seeking IPR and/or IPR-related opportunities owned by a third party, the method includes acquiring information from the law firm client on the IPR and/or IPR-related opportunity that the client is seeking, and posting the information on the IPR and/or IPR-related opportunity on the law firm website along with an indication that the client is seeking the IPR and/or IPR-related opportunity for possible commercial exploitation.

The law firm website provides a user-friendly interface that enables third parties as potential buyers, licensors, etc. to browse and learn of available IPR and IPR-related opportunities.

In an exemplary embodiment, the posted information can include a link to the IPR or IPR-related opportunity, and other information on the IPR or IPR-related opportunity. For example, if the IPR is a patent, the posted information can include the patent number, title, and/or an exemplary claim of the patent. The posting can also include contact information, either a contact at the law firm or a contact at the client, for a third party to obtain additional information. If the client is listed as the contact, a link could also be provided to the client's website.

### BRIEF DESCRIPTION OF DRAWINGS

FIG. 1 is a flow chart depicting concepts of the disclosed methods.

FIG. 2 illustrates an embodiment of a process of facilitating offers for possible commercial exploitation of IPR owned by a client of a law firm.

FIG. 3 illustrates an embodiment of a process of a law firm client seeking IPR.

FIG. 4 illustrates an embodiment of a system for implementing the methods disclosed herein.

FIG. 5 illustrates an exemplary embodiment of a posting of information on the law firm website of an IPR that is confidential.

FIG. 6 illustrates an exemplary embodiment of a posting of information on non-confidential IPR on a law firm web site.

FIG. 7 illustrates another exemplary embodiment of a posting of information of IPR in which financial funding is being sought.

FIG. 8 illustrates an exemplary embodiment of a posting of IPR information on a law firm web site viewable by registered clients.

FIG. 9 illustrates an exemplary embodiment of a posting of IPR information on a law firm web site viewable by registered clients and third parties.

FIG. 10 illustrates an example of a registration/inquiry screen on the law firm web site.

### DETAILED DESCRIPTION

This application discloses a number of concepts relating to methods for facilitating commercial exploitation of IPR and IPR-related opportunities by a law firm on behalf of law firm clients, including posting on a law firm website IPR and IPR-related opportunities owned by law firm clients that the clients of the law firm are interested in soliciting offers for possible commercial exploitation, and posting on a law firm website IPR, IPR-related opportunities, technology information, etc. sought by the law firm clients.

Prior to describing exemplary embodiments of the inventive concepts, a number of terms used throughout this application, including the claims, need to be defined.

“Law firm” means any type of law firm that engages in the practice of intellectual property law including, but not limited to, an intellectual property law boutique firm, a general practice law firm that engages in the practice of intellectual property law for its clients, a solo practitioner, a non-lawyer registered patent agent, affiliates and subsidiaries of the law firm, and other entities set-up separately from a law firm but where one or more individuals in the law firm have at least partial controlling interest in the entity.

“A client” of the law firm is an individual or an organization that is a client of the law firm through a prior or current working relationship, or an individual or an organization whose only relationship with the law firm is through engaging the services of the law firm to post IPR or IPR-related information on the law firm website.

“Third party” is an individual or organization interested in purchasing, licensing, providing funding for, or otherwise commercializing an IPR that is posted on the law firm website, or that has an IPR, venture, or IPR-related opportunity being sought by a law firm client that is posted on the law firm website. A third party can be a client of the law firm.

An intellectual property right or “IPR” includes, but is not limited to, a granted patent; a registered or unregistered trademark; a registered or unregistered copyright; a patent, trademark or copyright application; an application filing right such as a domestic or foreign filing right; know-how; expertise; trade secrets; confidential information; blue prints; drawings; and the like.

An “IPR-related opportunity” includes, but is not limited to, a funding opportunity, a joint venture opportunity, a business collaboration opportunity, a research and development opportunity, a partnership opportunity, and the like.

“Commercial exploitation” includes, but is not limited to, sale; exclusive or non-exclusive licensing; partial or total funding; trading; loaning; and the like.

A “law firm employee” includes, but is not limited to, an attorney; paralegal; assistant; or other person hired by the law firm.

As described in further detail below, the concepts described herein can help a law firm client that owns IPR or has an IPR-related opportunity commercially exploit that IPR or IPR-related opportunity. For example, if the law firm client has an invention for which a U.S. patent application has been filed but for which the client does not wish to pursue patent application filings outside the U.S., the concepts described herein can help the client sell the foreign filing rights that they do not wish to pursue. This allows the law firm client to derive commercial value from a right that they would have lost by not exercising their foreign filing rights. As another example, if the law firm client is looking for a third party to fund some research and development efforts, the concepts disclosed herein can help the law firm client find that third party.

In addition, the concepts described herein can also assist a law firm client that is seeking certain IPR, IPR-related opportunities, technology information, etc. with an eye toward acquiring rights in the IPR, IPR-related opportunities, technology information, etc. The concepts disclosed herein provide a forum for posting the IPR, IPR-related opportunities, technology information, etc. being sought by the client and to which third parties can turn who may have IPR, IPR-related opportunities, technology information, etc. that is being sought by the client.

For sake of convenience, the inventive concepts will hereinafter be described with respect to IPR, and the IPR specifically as a patent, patent application, and/or patent application filing rights. However, as discussed above, it is to be realized that the inventive concepts could apply to other types of IPR, including those specifically listed above, as well as to IPR-related opportunities, and that the claims are not limited to the IPR being a patent, patent application, and/or patent application filing rights, unless the claims expressly contain such a limitation.

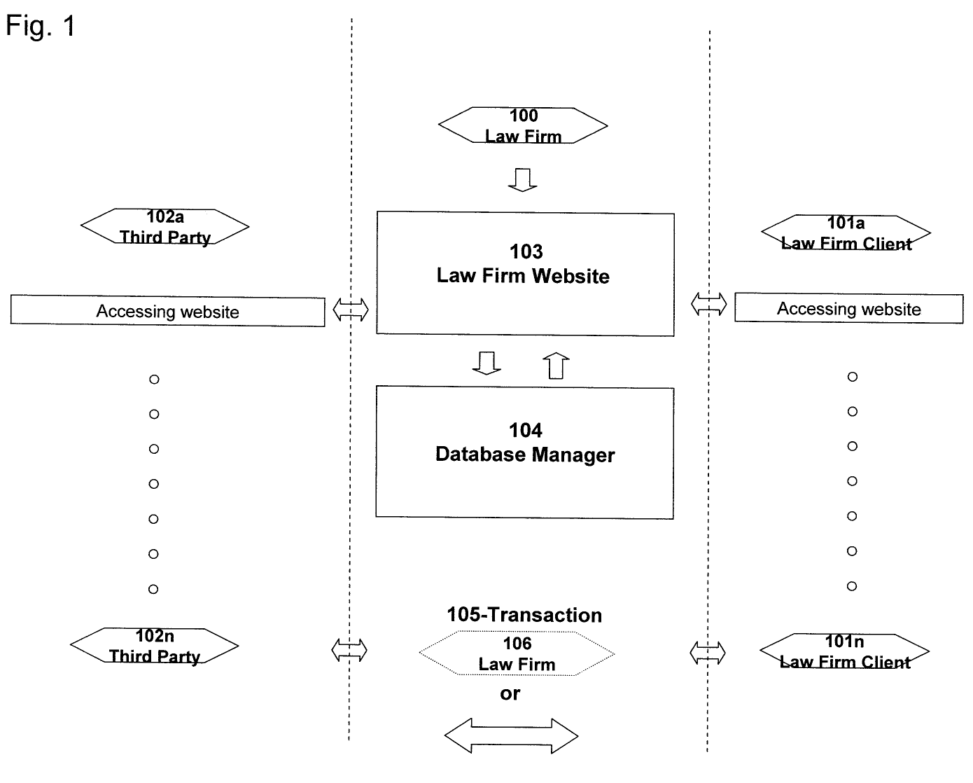

FIG. 1 is a flow chart depicts the overall concept. A law firm website 103 is made available by a law firm 100 on the internet. The law firm 100 acquires information from law firm clients 101a . . . n on IPR that the clients wish to post on the law firm website 103. The client's IPR information is then posted on the website 103. Third parties 102a . . . n may then go to the law firm website 103, view the posted on the IPR, and if interested, take further appropriate action, such as contacting a contact person for further information.

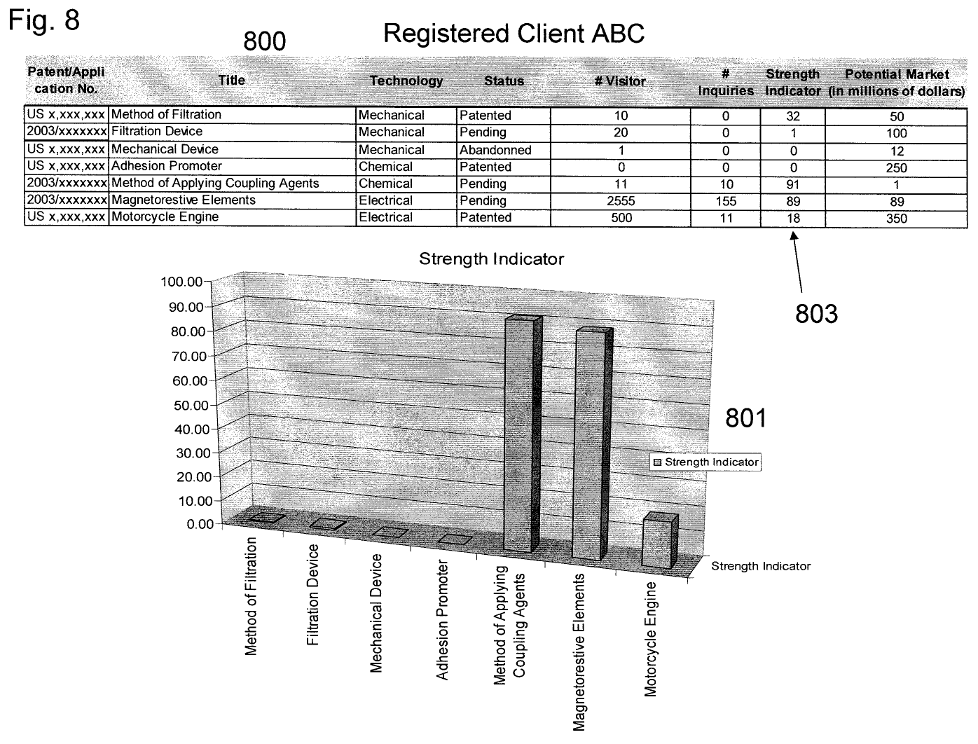

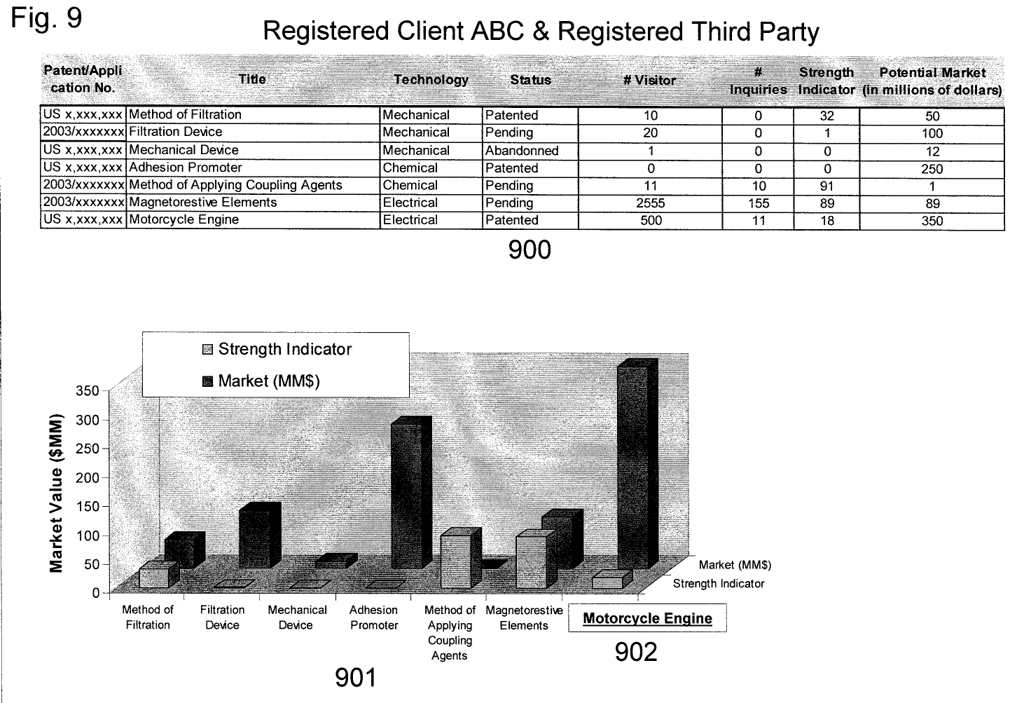

As will be described below with respect to FIGS. 8 and 9, the law firm clients 101a . . . n and the third parties 102a . . . n may also access the website 103 beyond the usual on-line internet access. For example, the clients 101a . . . n and the third parties 102a . . . n may be asked to register, with registration providing the client and third parties password access to additional information, for example discussed with respect to FIGS. 8 and 9, beyond just the posted IPR.

In some embodiments, all of the posted information on the IPR may be available for viewing by a third party 102a . . . n only after the third party registers with the law firm website 103. Once a third party is registered, the third party may then access the posted IPR information.

Activities occurring on the website 103 are preferably stored on a law firm database (or on a database of the law firm's web master) controlled by a database manager 104. Data to be stored includes, but is not limited to, the number of “hits” on a particular posted IPR, the name, type of business, size, and other information on the third party accessing the web site 103 or making an inquiry on a posted IPR, etc.

In the event that a third party 102a . . . n is interested in an IPR that is posted, the third party can contact the posted contact person, for example a law firm employee. As shown in FIG. 1, if the third party and law firm client are interested in a commercial transaction relating to the IPR, the law firm 100 may set up the business transaction 105, for example a purchase or license of the IPR, between the parties and act as an intermediary 106. Alternatively, the law firm may simply place the third party and law firm client in contact with each other to allow the two parties to directly conclude a commercial transaction.

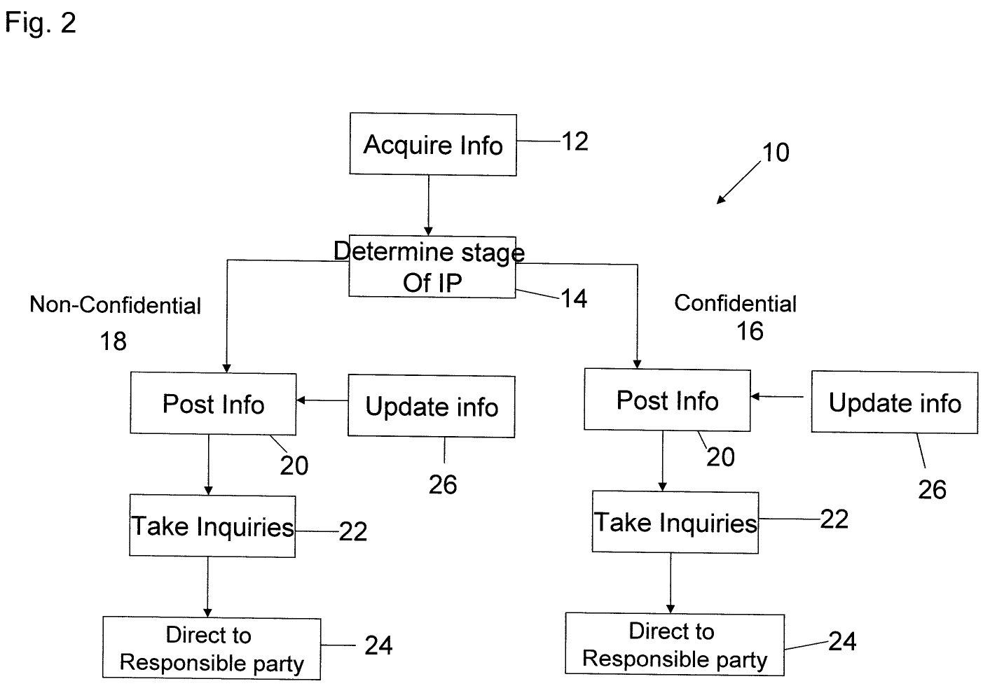

Referring to FIG. 2, an embodiment of a method 10 is illustrated in which IPR owned by a client of a law firm is posted on the law firm web site to facilitate offers for possible commercial exploitation of the client's IPR. In the method 10, information on the client's IPR that they wish to commercialize is acquired 12 by a law firm employee, for example an attorney representing the client. Next, the acquired information has to be screened and a determination made 14 as to the “stage” the IPR is in. The IPR the client wishes to commercialize may be generally categorized as either being in a “confidential” stage 16 or in a “non-confidential” stage 18. When the IPR is in the confidential stage 16, for example a pending U.S. patent application that has not yet been published, the information on that IPR that will be posted needs to preserve the confidential nature of the IPR. When the IPR is in the non-confidential stage 18, for example a pending U.S. patent application that has been published or a granted patent, a greater amount of information on that IPR can be posted.

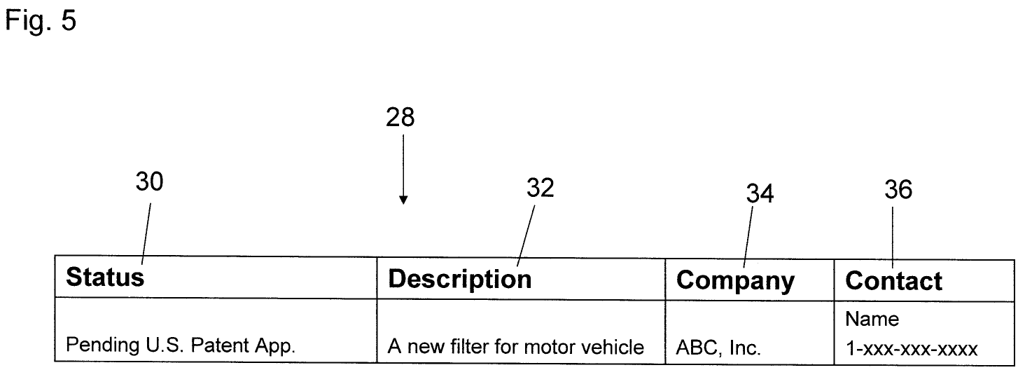

FIG. 5 shows an embodiment of a posting 28 for IPR, in this example a pending U.S. patent application that has not yet been published, that is in the confidential stage. In this example, the posting includes an indication of the status 30 of the application, a brief description 32 of the IPR, the name of the owner of the IPR 34, and contact information 36.

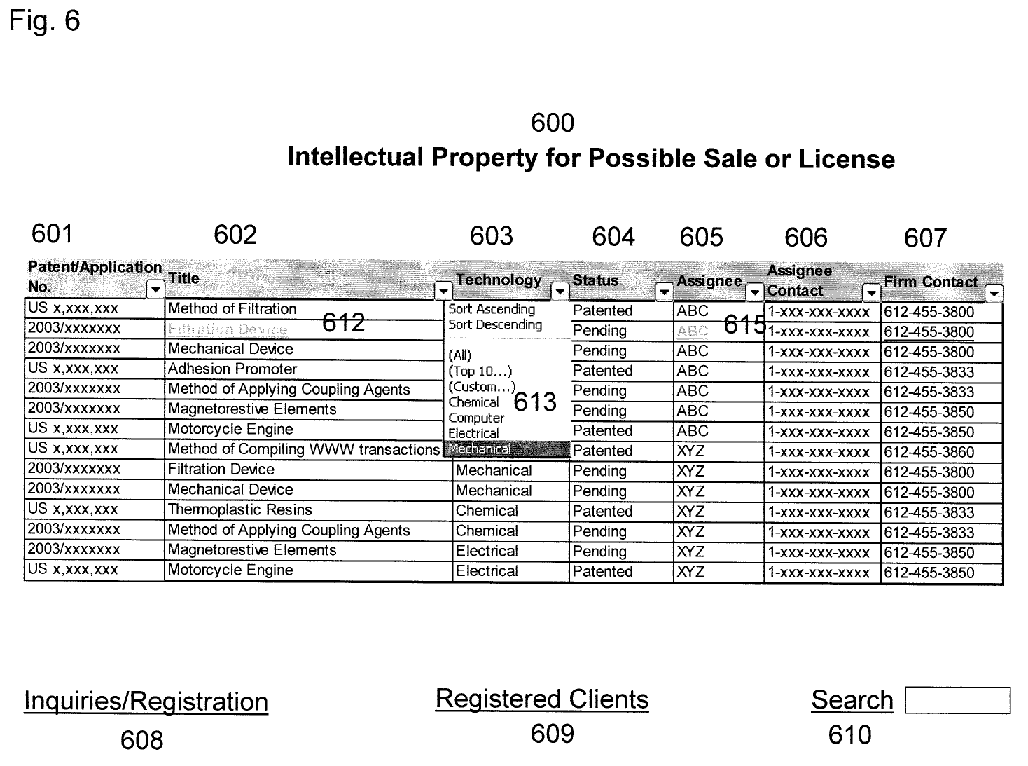

FIG. 6 shows an embodiment of a posting 600 for IPR, in this example pending U.S. patent applications that have been published and granted U.S. patents, which are in the non-confidential stage. Since the IPR is deemed to be non-confidential, more information relating to the IPR can be posted. FIG. 6 will be discussed in further detail below.

Returning to FIG. 2, regardless of whether the IPR is determined to be in a confidential stage 16 or a non-confidential stage 18, the appropriate information on the IPR is posted 20 on the law firm website. Once the IPR information is posted, any inquiries from third parties interested in the IPR are received 22 and directed to the responsible party 24 for handling the inquiry. The responsible party 24 can be, for example, the contact person listed on the website; a law firm employee assigned the responsibility for handling such inquiries, or an appropriate person at the law firm client. The third party inquiries can be automatically directed to the responsible party as a result of the third party completing a comment section or registering with the website, as will be discussed further below, or directed to the responsible party as a result of a letter written by the third party or a telephone call placed by the third party.

For either the confidential stage 16 or the non-confidential stage 18, the posted information 20 on the IPR can be updated 26 as necessary to reflect changes in the status of the IPR or to add/change information. For example, once a pending U.S. patent application, that was previously not published and therefore in the confidential stage 16, becomes published, the patent application is now in the non-confidential stage 18 and more information on the U.S. patent application can be posted, for example the patent application number.

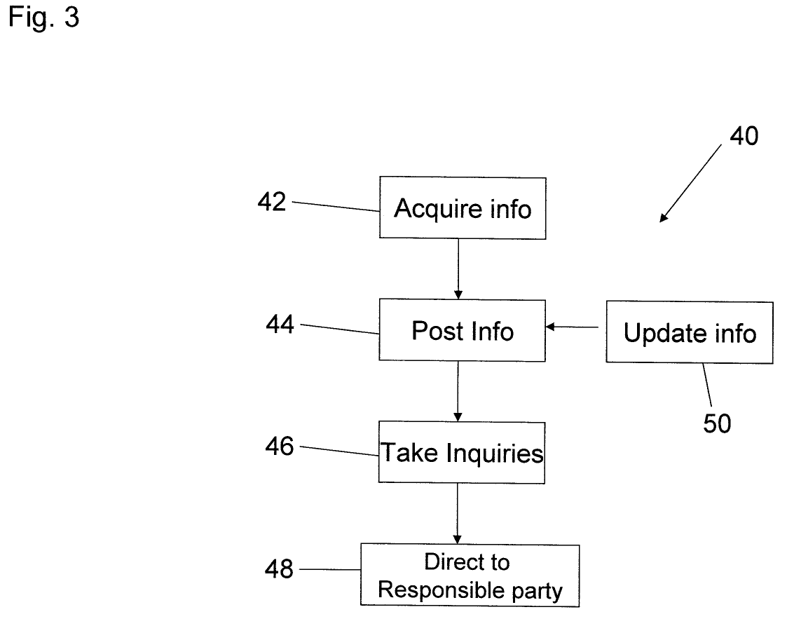

Referring to FIG. 3, an embodiment of a method 40 is illustrated in which information on an IPR-related opportunity that is available from the law firm client is posted on the law firm web site. In the method 40, information on the IPR-related opportunity that is available from the client is acquired 42 by a law firm employee, for example an attorney representing the client. The information is then posted 44 on the law firm website. Once the information is posted, any inquiries from third parties having interest in the IPR-related opportunity are received 46 and directed to the responsible party 48 for handling the inquiry. The posted information 44 can be updated 50 as necessary to reflect changes in the IPR-related opportunity and/or to add/change information.

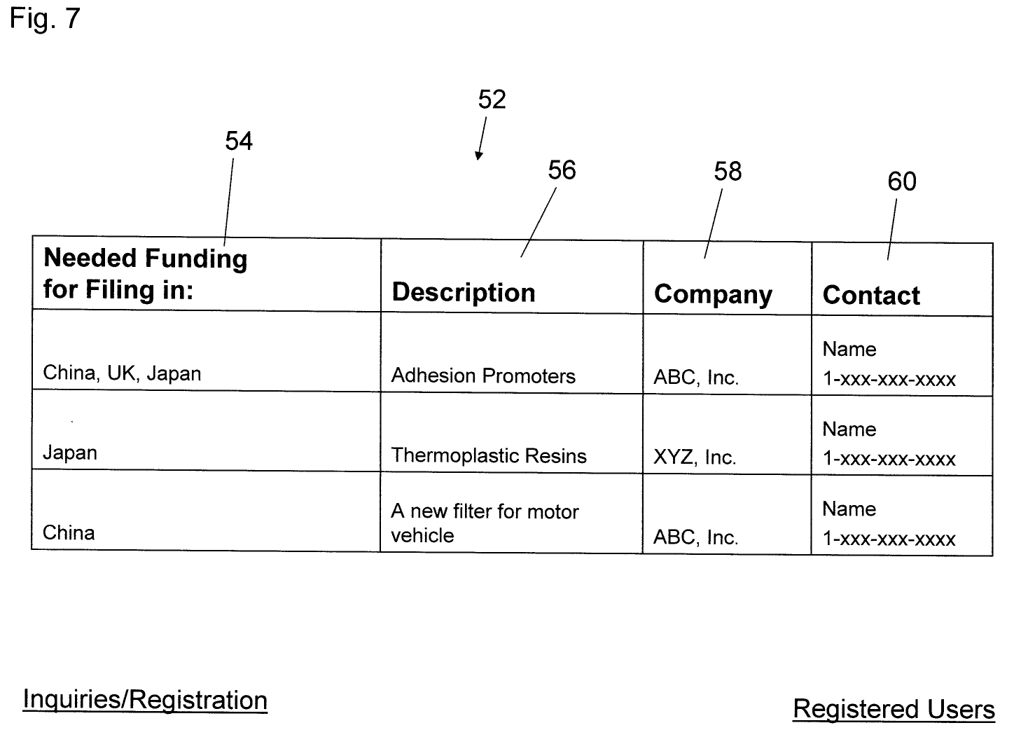

FIG. 7 illustrates an embodiment of a posting 52 on the law firm web site according to the method 40. In this example, the IPR-related opportunity is the law firm client looking for funding for pursuing patent application filings in various countries. The posting 52 includes information 54 on the IPR-related opportunity, along with an identification of the countries for which funding is being sought. The posting 52 also includes a brief description 56 of the technology, the name of the owner of the IPR-related opportunity 58, and contact information 60. Other fields such as links to the website of the patent office of the country, and time limits for completing the filings might also be posted.

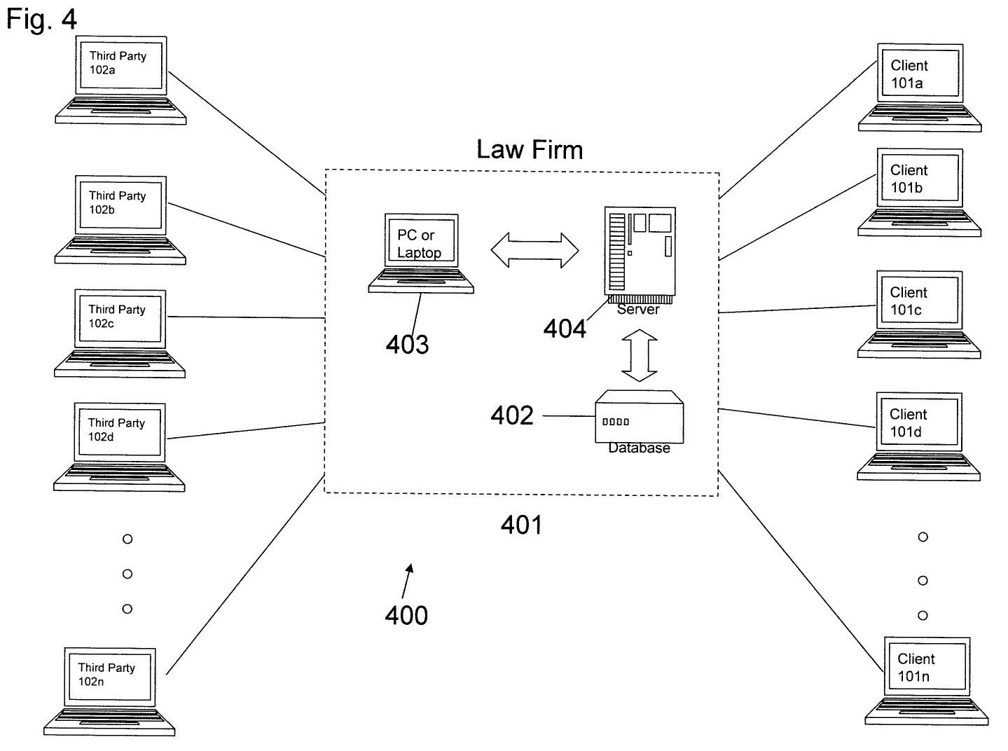

FIG. 4 illustrates an embodiment of a system 400 for implementing the methods disclosed herein. The law firm acts as an information exchange platform 401 to connect law firm clients and third parties. The information to be posted on the law firm website is stored in a database 402, with data entry through a PC or laptop 403 via a law firm server 404. The law firm clients 101a . . . n and the third parties 102a . . . n can access the exchange platform 401, i.e. the law firm web site, via the internet on a PC or laptop.

The interactions of a third party 102a . . . n with the law firm website can include, but is not limited to, viewing posted information, making inquiries, registering, and following provided links to other websites or information. Similarly, the law firm clients 101a . . . n can interact with website in the same way as a third party. In addition, in certain embodiments, the law firm clients may be provided with editing rights to allow the clients to edit the posted information.

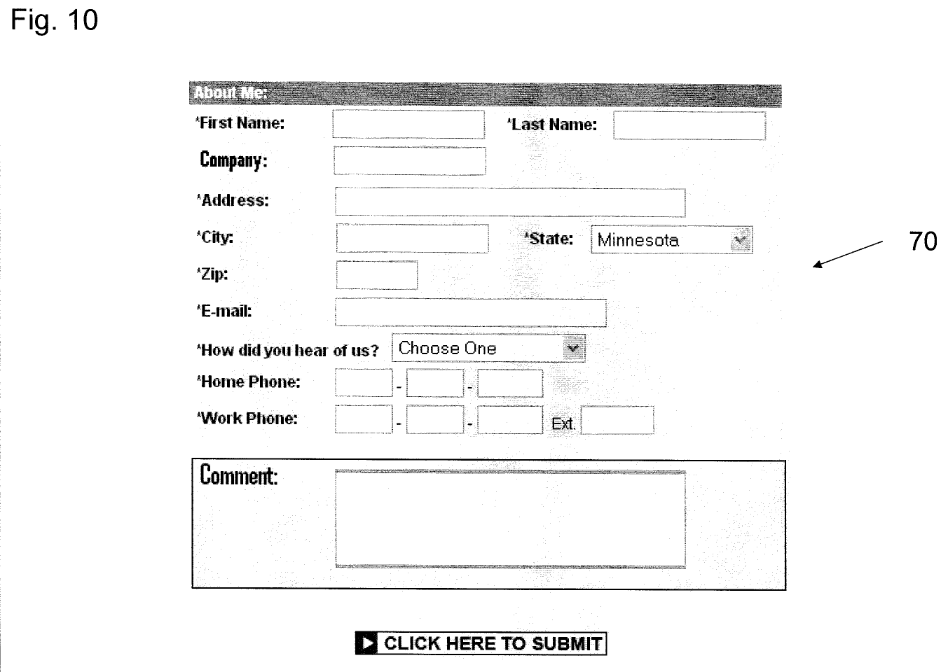

In addition, in certain embodiments, all clients and/or third parties may be required to be registered with the website in order to access the posted information. Registration may include completing a form 70 as shown in FIG. 10. The form 70 can include fields for entering name, address, company, contact information and an optional field to enter comments or inquiries. Once registered, the clients and third parties can be provided with a log-in ID and/or a password in order to access a protected area of the website for viewing and/or accessing the posted information.

As noted above, FIG. 6 illustrates an embodiment of a posting 600 for IPR, in this example pending U.S. patent applications that have been published and granted U.S. patents, which are in the non-confidential stage. The posting 600 can include, but is not limited to, a list of patents and patent applications 601, the titles of the patents and patent applications 602, an indication of the technology 603, the status 604, the assignee 605, assignee contact information 606 and contact information 607 for the law firm.

Preferably, any of the posted information is sortable by an interested party or law firm client by category. For example, as shown under the technology list 603, the technology may be sorted by category. Additional sortings can include by the country of the available IPR, or by assignee. The sortings can be selected from a drop down menu 613. Active links can also be provided on the posting 600 to direct a person to more information. For example, a link 612 can be provided to a published patent application or granted patent, and a link 615 to the website of the assignee.

Further, links can be provided to other locations, such as an Inquiries/Registration link 608 that links to the registration/inquiry form 70, a Registered Clients link 609 that links to portions of the website available only to registered clients, and a Search link 610 that allows a word search to be conducted.

FIG. 8 is an embodiment of a screen 800 available only to registered third parties, in this case ABC Company, and the law firm. The screen 800 can include a summary table of website activities relating to the posted IPR and IPR-related opportunities of the registered client. The summary table can include the number of visitors and inquiries made on each specific IPR and IPR-related opportunity for ABC Company. Further, the summary table includes a strength indicator column 803, wherein the strength indicator is calculated from website activities. In this instance, the strength indicator of an IPR is the sum of two variables X and Y multiplied by a factor of 100. Where X is the number of visitors of an IPR divided by the number of visitors of all IPR, and Y is the number of inquiries made divided by the number of visitors of an IPR.

Referring to the IPR titled “Motorcycle Engine” of FIG. 8; its strength indicator of 18 is calculated as follows:
X=11/(10+155+11)=0.16
Y=11/500=0.02
Strength indicator=(X+Y)*100=(0.16+0.02)*100=18

Other mathematical formulations and variables can also be used to indicate the interest of web users. For example, other formulations could include an arbitrary factor that reflects the random selections by visitors. Another example could include an industry factor that reflects the speciality of a technical field. The summary table can also include a list of the potential market for each listed IPR and IPR-related opportunity. The screen 800 can also include a graphical view of website activities, such as a graph 801 of strength indicator vs. IPR.

FIG. 9 is an embodiment of a screen 900 that can be made available only to registered clients, in this example ABC Company, and registered third parties. Many of the details listed in the table are similar to FIG. 8, including the number of visitors and inquiries made on a specific IPR and IPR-related opportunity for ABC Company, strength indicator, and potential market. A graphical view of website activities, such as a graph 901 of strength indicator and market value for each IPR, can also be provided. Further, links, for example link 902, can be provided to direct a viewer to other websites, postings, information, etc. on the IPR.

The law firm website and methods disclosed herein provide effective ways to connect law firm clients having IPR and/or IPR-related opportunities, or seeking IPR and/or IPR-related opportunities, with interested third parties 102a . . . n seeking IPR and/or IPR-related opportunities, or having IPR and/or IPR-related opportunities.

1. A method of facilitating commercial exploitation of intellectual property on a law firm website, where the intellectual property is owned by clients of the law firm, comprising:
acquiring information from a law firm client on intellectual property that the client wants to solicit offers for possible commercial exploitation; and
posting the information on the intellectual property on the law firm website along with an indication that the intellectual property is available for possible commercial exploitation.

2. On a law firm website, a method of facilitating commercial exploitation of intellectual property rights owned by clients of the law firm, comprising:
acquiring information from a law firm client on an intellectual property right that a client of the law firm is interested in commercializing;
posting the information on the intellectual property right on the law firm website to solicit inquiries from third parties expressing interest in commercializing the intellectual property right of the law firm client; and
posting an indication on the law firm website that the intellectual property right is available for possible commercial exploitation.

3. On a law firm website, a method of seeking intellectual property for possible commercial exploitation, comprising:
acquiring information from a law firm client on intellectual property that the client is seeking; and
posting the information on the intellectual property being sought by the law firm client on the law firm website along with an indication that the client is seeking the intellectual property.
